(19) United States
(12) Patent Application Publication
(10) Pub. No.: US 2021/0242692 A1
(43) Pub. Date: Aug. 5, 2021

(54) FLEXIBLY CONFIGURABLE TRACTION BATTERY

(71) Applicant: Byton Limied, Hong Kong (HK)

(72) Inventor: Wei ZHOU, Ingolstadt (DE)

(21) Appl. No.: 17/054,163

(22) PCT Filed: May 9, 2018
(86) PCT No.: PCT/EP2018/062155

§ 371 Date: Nov. 9, 2020

(51) Int. Cl. H02J 7/00; B60L 58/18; H01M 10/44; H01M 10/42

(52) U.S. Cl. CPC H02J 7/0024; B60L 58/18; H01M 2220/20; H01M 10/425; H01M 2010/4271; H01M 10/441

(57) ABSTRACT

The present disclosure inter alia relates to a battery module (100) for a traction battery (1000) of an electric vehicle (EV), wherein the battery module (100) has a number N of battery cells (1; 1a, 1b, 1c, 1d), each having a first terminal (4) and a second terminal (6), as well as a configuration circuit (30) for selectively configuring the interconnection of the battery cells (1; 1a, 1b, 1c, 1d) to change a module pole voltage (MS) between battery-module terminals (114, 116) of the battery module (100), wherein the configuration circuit (30) is connected to all first and second terminals (4, 6) of the battery cells (1; 1a, 1b, 1c, 1d) and is arranged to form a first number S of battery-cell groups, each of which contains a second number P of battery cells, in that the configuration circuit (30) can connect all battery cells of a battery-cell group in parallel and interconnect the battery-cell groups in series, wherein the selectable interconnection configurations meet the condition P×S=N.

### FIELD

The present disclosure relates, in general, to the storage of electrical energy. In particular, the present disclosure relates to a rechargeable electrical energy storage device that can be configured flexibly to optimize the charging time and to supply connected electrical consumers in an energy-efficient manner. More particular, the present disclosure relates to such a rechargeable electrical energy storage device for use in an electrical vehicle.

### BACKGROUND

The following background information is provided solely to facilitate understanding of the present disclosure and should by no means be construed as an admitted prior art unless expressly designated as such.

Energy storage devices for electrical energy—in particular, for electric vehicles—are known. The capacity of an energy storage device located on-board an electric vehicle, as well as the time required to recharge this energy storage device, are decisive for the possible application profile of the vehicle and thus its acceptance on the market. The capacity of the energy storage device essentially determines the range of the electric vehicle, while the charging determines the period of time until the electric vehicle is available with sufficient range again for the user.

In his article, “laden mit 800 V” (English: Charging with 800 V), which was published in the “Porsche Engineering Magazine,” issue 1/2016, Volker Reber describes the effects on the charging process of the energy storage device as such resulting from a doubling of the currently customary charging voltage of 400 V, as well as the associated impact on the total travel time that results for long routes that go beyond the range of the electric vehicle predetermined by the energy storage capacity. The battery technology proposed for this purpose presupposes that the vehicle has an 800 V on-board battery and a corresponding on-board system. However, to ensure compatibility with the 400 V system components established on the market and with the 400 V charging voltage of the existing infrastructure, numerous additional components are necessary in the vehicle. For example, a step-up converter is required on the sides of the charging interface to step up the charging voltage at a 400 V charging station to the 800 V charging voltage required for the 800 V on-board battery. It is also necessary for the vehicle to have step-down converters to, if necessary, step down the output voltage of the 800 V on-board battery to the 400 V on-board voltage that is customary at the present time. This increases the complexity of the electric vehicle's system, as well as the system price.

DE 10 2016 015 314 A1 discloses an electric drive system having a battery and an electric three-phase machine for a vehicle. The drive system has two separate three-phase systems, wherein the two three-phase systems are each electrically coupled to one inverter, and the inverters are electrically coupled to different electrochemical sub-areas from different ca groups of the battery. Via a switching unit, the electrochemical sub-areas of the battery can be connected electrically in series or electrically separated from one another. Galvanic separation of the electrochemical sub-areas results in a redundancy that enhances the fail-safe characteristics of the energy supply of the three-phase machine. Furthermore, vehicle components can be supplied with a low sub-area voltage of the overall battery (for example, 400 V), while, on the other hand, a higher charging voltage (in the example, 800 V) can be used to charge the battery faster.

### SUMMARY

One aim of the present disclosure is to propose a solution by means of which an energy storage device—such as a traction battery of an electric vehicle—can, for certain requirements, be configured for a charging and/or discharging process in more energy efficient.

With respect to the charging process, it could, for example, be desirable if the energy storage device could be configured for a charging process in such a way that it could be charged as fast as possible. With respect to the discharging process, it could, for example, be desirable if the energy storage device could be configured for supplying connected consumers in a more energy-efficient manner.

The aim may be achieved, in particular embodiments, defined with the features of the independent claims. Further exemplary embodiments and further embodiments are defined in the respective dependent claims. Here, features and details that are defined in connection with the energy storage device according to the present disclosure are also, of course, valid in connection with the corresponding traction battery, electric drive system, and electric vehicle, as well as for a corresponding energy storage method according to the present disclosure, and vice versa. For this reason, reciprocal reference is made with respect to the present disclosure of the individual aspects.

The core concept of the present disclosure is a battery module that consists of several secondary (battery) cells, the interconnection of which can, if necessary, be configured flexibly between the module terminals by means of an internal configuration circuit in such a way that different module voltages can be set at the module terminals for, and/or during, a charging process or discharge process. The battery modules are quasi-standardized in terms of design and can easily be manufactured as a mass-produced product in any number of units. A traction battery can be constructed from several battery modules, wherein, in a certain embodiment, the several battery modules are connected in series.

A first aspect of the present disclosure thus relates to a battery module for a traction battery of an electric vehicle. The battery module has: At least two battery-module terminals for receiving and/or supplying electrical energy; and a number N of battery cells, each having a first terminal and a second terminal, as well as a configuration circuit for selectively configuring an (intended) interconnection of the battery cells in order to change a module pole voltage between the battery-module terminals of the battery module. The configuration circuit is connected to all first and second terminals of the battery cells and arranged to form a first number S of battery-cell groups, each containing a second number P of battery cells, in that the configuration circuit can connect all battery cells of a battery-cell group in parallel and interconnect the battery-cell groups in series. Each of the adjustable interconnections of the battery cells thus meets the condition P×S=N, i.e., all battery-cell groups are formed by the same number of battery cells. This also ensures that the capacity of the groups formed is essentially identical with respect to their ability to receive power and supply power.

For the purpose of interconnecting the battery cells to one another, the configuration circuit has electrically controllable switching elements between the battery-module terminals. Thus, in (N−2) battery cells of the N battery cells, the first terminal of a particular one battery cell can be connected electrically to the first terminals of two other battery cells of the N battery cells, and the second terminal of this articular battery cell can be connected electrically to the second terminals of these two other battery cells, respectively by means of one of the controllable switching elements. Furthermore, in the (N−2) battery cells of the N battery cells, the first terminal of a particular one battery cell can be connected electrically to the second terminal of a first battery cell of the two other battery cells, and the second terminal of the particular one battery cell can be connected electrically to a first terminal of a second battery cell of the two other battery cells, respectively by means of one of the controllable switching elements.

In a terminal battery cell of the N battery cells, one of the first terminal and the second terminal is fixedly connected to one of the two battery-module terminals. Since there are two battery-module terminals, there are two terminal battery cells.

In a terminal battery cell, the first terminal and the second terminal can each be connected to a corresponding first terminal or second terminal of one of the other (N−2) battery cells by means of one of the controllable switching elements, respectively. Furthermore, in a terminal battery cell, the other of the first terminal and the second terminal, which is not connected to one of the two battery-module terminals, can additionally be connected to one of the first and second terminals of the one battery cell of the other (N−2) battery modules by means of one of the controllable switching elements.

That is to say, when the first terminal of the terminal battery cell is connected to one of the two battery-module terminals, the second terminal of the terminal battery cell can be connected to the first terminal of the one battery cell of the other (N−2) battery cells by means of one of the controllable switching elements. Otherwise, when the second terminal of the terminal battery cell is connected to one of the two battery-module terminals, the first terminal of the terminal battery cell can be connected to the second terminal of the one battery cell of the other (N−2) battery cells by means of one of the controllable switching elements.

The controllable switching elements can each have at least one power semiconductor that is controllable as a switch. The switching elements can each have at least one power semiconductor from the following group, consisting of: insulated-gate bipolar transistors (IGBT), power metal oxide semiconductor field-effect transistors (power MOSFET's), and thyristor switches. An insulated-gate bipolar transistor (IGBT) is well suited, because it is a semiconductor device that unites the characteristics of a bipolar transistor in terms of current passage response, blocking voltage, and durability with those of a field-effect transistor, due to the almost powerless controllability, and can thus be used well as a controllable switching element. Power MOSFET's (power metal oxide semiconductor field-effect transistor), which are essentially a specialized version of a MOSFET that is optimized for conducting and blocking large electrical currents and voltages, are also suitable as a controllable switching element.

The battery cells of the battery module are each secondary battery cells and, due to the electrochemical design, have a certain nominal battery-cell voltage.

The (nominal) battery-module voltage of the battery module can be configured in stages, with the magnitude of (nominal) battery-cell voltage ZS or a multiple of (nominal) battery-cell voltage ZS in a range from a (nominal) battery-cell voltage ZS (all battery cells are connected in parallel) up to the N-fold (nominal) battery-cell voltage N×ZS (if all battery cells are connected in series), by controlling the controllable switching elements accordingly.

In other words, the (nominal) battery-module voltage corresponds to the (nominal) battery-cell voltage ZS if all battery cells are connected in parallel. In this case, all battery cells form a single battery-cell group (1S) in which all N battery cells (NP) are connected in parallel. This configuration is here referred to as 1SNP, which means that, when there are four battery cells, i.e., N=4, the configuration is referred to as 1S4P. A second extreme case is the one in which all N battery cells are connected to each other in series. In this case, the (nominal) battery-module voltage corresponds to the N-fold of (nominal) battery-ca voltage ZS. This configuration is here referred to as NS1P, which means that, when N=4, the configuration is referred to as 4S1P. According to the aforementioned dimensioning rule S×P=N, the number of battery cells P in each of the S battery cell croups is the same.

If a battery cell is, for example, a lithium-ion battery cell, the nominal battery-cell voltage is, for example, approx. 3.7 V because of the electrochemical potential series, wherein the cell voltage varies between about 2.7 V (completely discharged) and 4.2 V (fully charged), depending upon which cell chemistry is used. If the number N of battery cells is 10 (i.e., N=10), battery-module voltage MS can be set to 37 V by means of the 1P10S configuration. In the 10P1S configuration, the battery-module voltage is, by contrast, 3.7 V.

For example, a traction battery having 10 battery modules connected in series, each having 22 lithium-ion battery cells, could be constructed for a 400 V drive system of an electric vehicle. If all battery modules are set to the 1P22S configuration, there results, for each battery module, a battery-module voltage MS of 81.4 V and, as a traction battery voltage, a voltage of 10×81.4 V=814 V. This would make it possible to charge the traction battery at an 800 V charging station. To supply the 400 V drive system, all battery modules would be set to the 2P11S configuration, resulting in, for each battery module, a battery-module voltage MS of 40.7 and, as a traction battery voltage, a voltage of 10×40.7 V=407 V. This would make it possible for the traction battery to supply the 400 V drive system.

The battery module can also have a battery-module control unit that is operatively connected to the controllable switching elements of the configuration circuit of the battery module. Here, “operatively connected” means that the battery-module control unit is connected to the switching elements, in an active relationship. The battery-module control unit can selectively control the controllable switching elements in such a way that a controlled switching element closes or opens, and thus produces or interrupts, a respective connection between the relevant terminals of two battery cells.

The battery module can also have a battery-module control input for receiving a module voltage control signal for setting a selectable module voltage at the battery-module terminals, wherein the control input is connected to the battery-module control unit.

The battery-module control unit can be arranged to control the configuration circuit according to the module voltage control signal, in order to configure the interconnection of the N battery cells of the battery module in such a way that the module voltage is set according to the module voltage control signal.

A second aspect of the present disclosure relates to a traction battery—for example suitable for an electric vehicle—having at least two traction battery terminals, several battery modules according to the first aspect discussed above, and a traction battery control unit.

In one particular embodiment, the battery modules in the traction battery are connected to each other in series, and between the two traction battery terminals.

The traction battery control unit, via a battery-module control output, can be operatively connected to the respective battery-module control inputs of the battery modules for the purpose of communication of control and status information, in order to set the configuration of the individual battery modules according to need.

For example, the traction battery control unit, via the battery-module control output and the respective battery-module control inputs of the battery modules, can be connected operatively via a communication bus. The communication bus can, for example, be a fieldbus, such as a CAN bus (as defined in ISO 11898, ISO 11898-2/high-speed CAN, or ISO 11898-3/low-speed CAN) or RexRay (as defined in ISO 17458-1 to 17458-5), to name two examples, or it can be any other suitable control bus. Of course, the traction battery control unit can also be wired to each individual battery module individually, to communicate control and status information.

For a first application scenario, the drive battery control unit can also be operatively coupled to a charging voltage unit—for example, as part of a charging unit (charger). A charging unit essentially contains an electronic circuit with a charge controller, and controls the charging process for the traction battery. For, the type of charging method used is implemented in the charging unit. The charging unit is supplied externally with power, e.g., supplied from the public power network in the form of a charging station for charging electric cars or from a private island network. The charging voltage unit can be arranged to determine the magnitude of an available charging voltage and transmit it to the traction battery control unit.

For, the charging voltage unit can be arranged for data exchange with a charging station for charging electric cars in accordance with the ISO standard 15118 or the Chinese standard GB/T 27930 (Communication protocols between off-board conductive charger and battery management system for electric vehicle), such that the charging voltage unit can ascertain (for example, query) a maximum available charging voltage at the available charging station or request the maximum possible charging voltage for the traction battery at the charging station.

In any case, for the context of the present disclosure, the charging voltage unit is arranged to inform the traction battery control unit which traction battery voltage the traction battery is to be adjusted to, by reconfiguring the battery modules.

Accordingly, the traction battery control unit can be arranged to control the several battery modules such that the traction battery is configured as a whole in such a way that, at the two traction battery terminals, a traction battery voltage is set that matches the available or requested charging voltage.

For a second application scenario, the traction battery control unit can, in addition or alternatively to the first scenario, be arranged such that it controls the several battery modules in such a way that, when electrical energy is drawn from the traction battery, the traction battery is configured as a whole in such a way that, at the two traction battery terminals, a traction battery voltage corresponding to a predetermined drive voltage is set for supplying an electric drive with electrical energy.

In a further embodiment of the second application scenario, it may be taken into consideration that an electric motor, as an electric drive, has an efficiency profile. Here, “efficiency profile” is intended to mean that the electric drive can primarily work in a particular energy-efficient manner in a predetermined range of the drive voltage provided to the drive.

For this purpose, the traction battery control unit can further be arranged such that it controls the several battery modules in such a way that, when the traction battery is supposed to deliver energy to the electric drive, the traction battery is configured as a whole in such a way that the traction battery voltage set at the two traction voltage terminals is within the predetermined range of efficiency of the efficiency profile of the electric drive, or comes as dose to it as possible.

As a result, it is possible, by means of the flexible configuration of the battery modules, for a reduction in the individual battery-cell voltages, due to the normal discharge cycle or also due to the aging of the battery cells, to be compensated for by interconnecting the battery cells in the battery modules accordingly. This means that, in the normal discharge cycle, the battery-cell voltages of the individual battery cells decrease. Accordingly, the overall traction battery voltage naturally decreases. The configurability of the battery modules according to the present disclosure, despite a reduction in the individual battery-cell voltages, allows a higher traction battery voltage to be ensured for a longer period of time, in order to operate the electric drive within the range of optimum efficiency of the efficiency profile.

A third aspect relates to an electric drive system—for example, particular suitable for an electric vehicle—having at least one electric motor as an electric drive and having a traction battery according to the second aspect discussed above for supplying the electric drive (e.g., the electric motor) with electrical energy.

For example, the electric drive can have an electric motor in the form of a direct-current motor that is connected to the traction battery, or an electric motor in the form of a three-phase motor that is connected to the traction battery via an inverter. The components of the electric motor can have the efficiency profile addressed above with respect to the drive voltage.

A fourth aspect relates to an electric vehicle having an electric drive system according to the third aspect discussed above.

The electric vehicle can be an automobile, but can, in principle, also be any other vehicle, such as an aircraft, watercraft, or rail vehicle. The electric vehicle can have only the electric drive system, but can also be a hybrid vehicle that additionally has another type of drive, such as a conventional internal combustion engine or a fuel cell.

The flexibly configurable battery modules according to the present disclosure can be used to design traction batteries that can realize high charging voltages, and thus shorter charging times, without additional vehicle-side expenditures, on the one hand, and, on the other, be configured during operation to supply available system components that are, currently, usually designed for a 400 V system voltage. This allows the electric vehicles of today to be prepared for the charging voltages of tomorrow in a future-proof manner.

The battery modules according to the present disclosure have a particular simple and standardized design. They can easily be produced as a mass-production product in high quantities. Compared to conventional battery modules, all battery cells in the battery module according to the present disclosure can be packed into a battery module in the same orientation as the phis and minus pole terminals. This simplifies the manufacturing process, because the installation direction does not need to be monitored in a dedicated manner.

### BRIEF DESCRIPTION OF THE DRAWING FIGURES

Other advantages, features, and details of the present disclosure arise from the following description, in which exemplary embodiments of the present disclosure are described in detail with reference to drawings. The features described in the claims and in the description may be relevant to the present disclosure individually or in any combination. Likewise, the features mentioned above and below can each be used individually or collectively in any combination. Functionally similar or identical parts or components are in some cases labelled with the same reference symbols. The terms, “left”, “right”, “up,” and “down,” used in the description of the exemplary embodiments relate to the drawings in an orientation with the legends legible in the normal fashion or reference characters legible in the normal fashion. The embodiments shown and described are not to be taken as exhaustive, but serve as examples for explaining the present disclosure. The detailed description is for the information of those of ordinary skid in the art, which is why known structures and methods are not shown or explained in detail in the description, to avoid complicating the understanding of the present description.

FIG. 1A shows a simplified block diagram of a battery cell.

FIG. 1B shows a simplified block diagram of a battery module.

FIG. 2A shows a simplified block diagram of a battery module having N=4 battery cells in a 2P2S configuration.

FIG. 2B shows the battery module of FIG. 2A in a 1P4S configuration.

FIG. 3A shows a simplified exemplary embodiment of a flexibly configurable battery module based upon the exemplary battery module of FIG. 1B.

FIG. 3B shows a further representation of the exemplary embodiment of FIG. 3A.

FIG. 4A shows a perspectival exploded view drawing of a possible exemplary embodiment of a battery module.

FIGS. 4B-4C show a perspectival representation of the upper side and the underside of the configuration circuit of the exemplary embodiment of the battery module in FIG. 4A.

FIG. 5 shows a simplified block diagram of a flexibly configurable traction battery that is constructed from several battery modules connected in series, such as the one from FIG. 3.

FIG. 6 shows a simplified block diagram of an electric drive system having a traction battery, such as the one from FIG. 5.

FIG. 7 shows a simplified block diagram of an electric vehicle having a drive system, such as the one from FIG. 6.

### DETAILED DESCRIPTION OF EXEMPLARY EMBODIMENTS

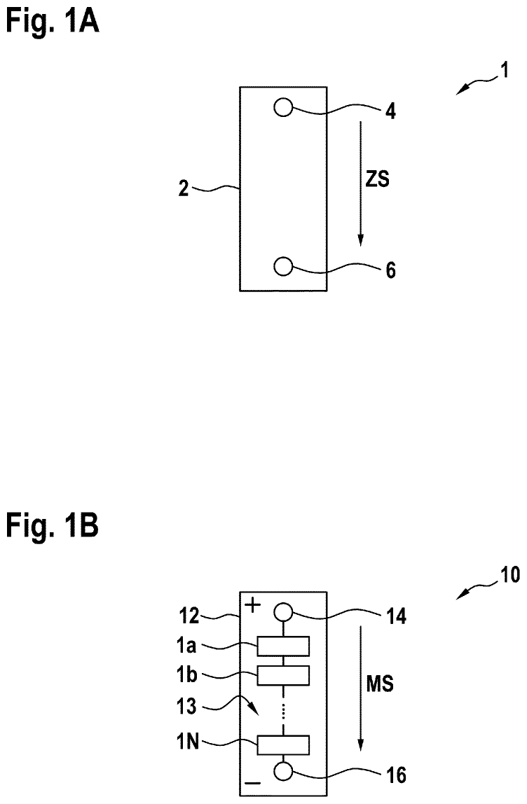

FIG. 1A shows a simplified block diagram of a battery cell 1. Battery cell 1 is a secondary cell, i.e., a battery cell having a battery cell housing 2 and an electrochemical structure housed therein that permits recharging. Each secondary cell has a nominal (battery) cell voltage ZS typical of the electrochemical potential series by means of cell materials used for the cell construction. For example, battery cell 1 can be a lithium-ion battery cell that, in the charged state, supplies a nominal battery-cell voltage of, for example, 3.7 V between a first (battery cell) terminal 4 and a second (battery cell) terminal 6. The basic and possible construction of battery cells 1 is assumed to be sufficiently known to those of ordinary skill in the art and is therefore not described further.

FIG. 1B shows a simplified block diagram of a battery module 10. Battery module 10 is essentially constructed in a manner known per se from a number N of battery cells 1a, 1b, . . . 1N, such as battery cell 1 of FIG. 1, wherein battery cells 1a, 1b, . . . 1N are combined into a (battery) module housing 12 having a (battery) module cover 13. A nominal (battery) module voltage MS that is the N-fold of the battery-cell voltage arises between a first and a second (battery) module terminal 14 and 16.

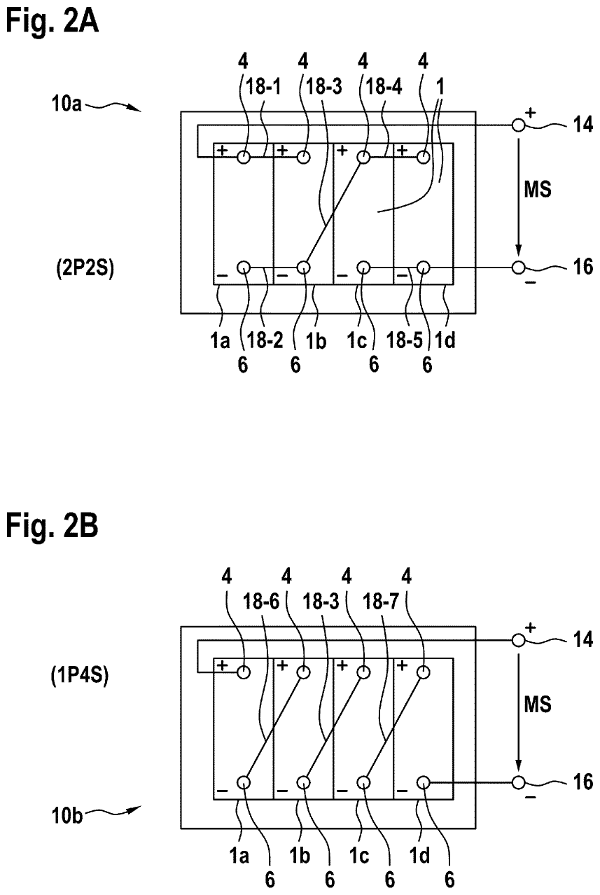

FIG. 2A shows a simplified block diagram of a (battery) module 10a having N=4 battery cells 1a, 1b, 1c, 1d. The N=4 battery cells can each, for example, be a battery cell 1 from FIG. 1. In any case, battery cells 1a, 1b, 1c, 1d are essentially identical.

In FIG. 2A, battery cells 1a, 1b, 1c, 1d according to the designation defined in this document are connected in the 2P2S configuration. That means that the N=4 battery cells 1a, 1b, 1c, 1d are configured in 2 battery-cell groups (S=2) with respectively two (2P) battery cells 1a, 1b and 1c, 1d connected in parallel. The 2P2S configuration shown in FIG. 2A is fixedly set by connecting the four battery cells 1a, 1b, 1c, 1d to electrically conductive connecting bridges 18-1 to 18-5.

For example, let it be assumed that the battery cells are lithium-ion battery cells having a nominal (battery) cell voltage ZS of 3.7 V. Thus, module 10a of FIG. 2A has a nominal (battery) module voltage MS of 7.4 V, with a capacity equal to the capacity of 2 battery cells 1. Module voltage MS of module 10a is between first and second module terminals 14 and 16.

As a further example, FIG. 2B shows a module 10b that essentially corresponds to the module of 2A. However, in module 10b, battery cells 1a, 1b, 1c, 1d are connected in the 1P4S configuration. For this purpose, all four battery cells 1a, 1b, 1c, 1d are connected to one another in series by means of three connecting bridges 18-6, 18-3, 18-7. Thus, in accordance with the assumptions for the example of FIG. 2A, a nominal module voltage of 14.8 V arises as a nominal module voltage MS in FIG. 2B for module 10b.

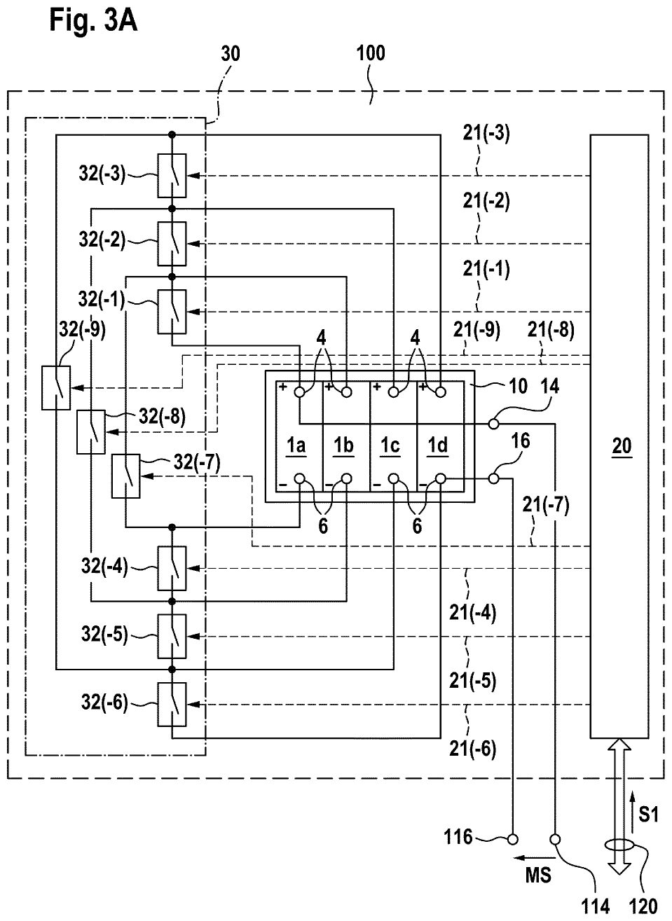

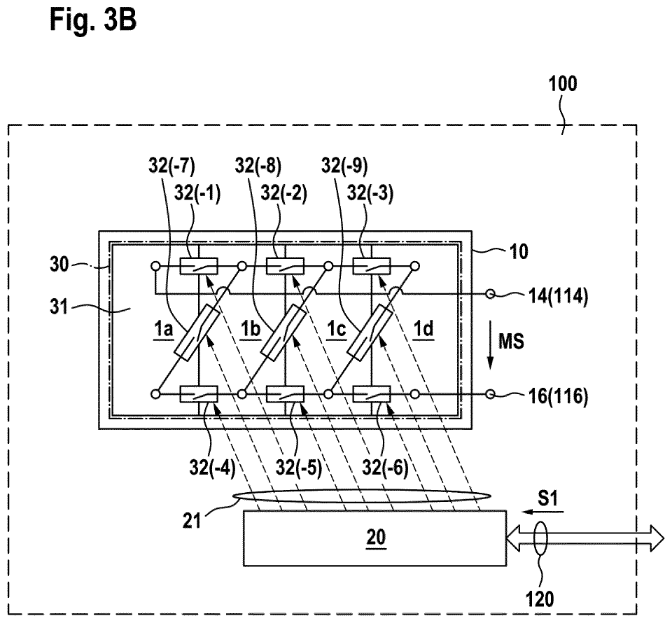

FIG. 3A shows a simplified exemplary embodiment of the flexibly configurable (battery) module 100 proposed here, which is essentially a further embodiment according to the present disclosure of (battery) module 10 of FIG. 1B.

Module 100 of FIG. 3A again has a number of N=4 battery cells 1a, 1b, 1c, 1d with respective first terminals 4 and second terminals 6. Of course, the number of battery cells is arbitrary and, above all, in a practical design, larger; the number N=4 has only been selected here for the purpose of a simplified explanation. First terminals 4 are the positive poles of battery cells 1a, 1b, 1c, 1d, and second terminals 6 are the negative poles of battery cells 1a, 1b, 1c, 1d.

Furthermore, module 100 has, in comparison with FIG. 1B, a configuration circuit 30 for selectively setting the (battery) module voltage MS of module 100 on a first and second (battery) module terminal 114, 116.

Configuration circuit 30 is connected to all first terminals 4 and all second terminals 6 of battery cells 1a, 1b, 1c, 1d. Furthermore, configuration circuit 30 is arranged in such a way that a first number S of battery-cell groups connected in series, each containing a second number P of battery cells connected in parallel, can be configured. For this purpose, configuration circuit 30 can connect all P battery cells in each battery-cell group in parallel and connect the S battery-cell groups to each other in series. In principle, P×S=N always applies to all switchable configurations.

For the purpose described above, configuration circuit 30 has electrically controllable switching elements 32-1, 32-2, 32-3, 32-4, 32-5, 32-6, 32-7, 32-8, 32-9 (32-1, . . . 32-9). Controllable switching elements 32-1, . . . 32-9 may be implemented as power semiconductors that are controllable as a switch. Examples of suitable switching elements include insulated-gate bipolar transistors (IGBT), power metal oxide semiconductor field-effect transistors (power MOSFET), or thyristor switches.

In (N−2) battery cells, i.e., in the example shown, the two battery cells 1b, 1c of N=4 battery cells 1a, 1b, 1c, 1d in the exemplary embodiment of FIG. 3A, first terminal 4 can be connected electrically in each case to first terminals 4 of two other (each immediately adjacent) battery cells 1a, 1c and 1b, 1d of N=4 battery cells 1a, 1b, 1c, 1d by means of a controllable switching element 32-1, 32-2 and 32-2, 32-3. Furthermore, second terminal 6 of battery cells 1b and 1c can be connected electrically to second terminals 6 of these two other battery cells 1a, 1c and 1b, 1d by means of a respective controllable switching element 32-4, 32-5 and 32-5, 32-6.

For example, the following applies to battery cells 1b, which is one of the (N−2=4) battery cells: First terminal 4 of battery cell 1b is connected to first terminals 4 of battery cells 1a and 1c by means of switching elements 32-1 and 32-2. Second terminal 6 of battery cell 1b is connected to second terminals 6 of battery cells 1a and 1c by means of switching elements 32-4 and 32-5.

In (N−2) battery cells, i.e., in the two battery cells 1b, 1c of N=4 battery cells 1a, 1b, 1c, 1d in the exemplary embodiment of FIG. 3A, first terminal 4 can further be connected electrically to second terminal 6 of a first battery cells 1a or 1b of the two other (each immediately adjacent) battery cells 1a, 1c or 1b, 1d, each by means of a respective controllable switching element 32-7, 32-8, and second terminal 6 can be connected electrically to a first terminal 4 of second battery cells 1c or 1d of the two (each immediately adjacent) other battery modules 1a, 1c and 1b, 1d, each by means of a respective controllable switching element 32-8, 32-9.

For example, the following applies to battery cell 1b, which is one of the (N−2=4) battery cells: First terminal 4 of battery cell 1b is connected to second terminal 6 of battery cells 1a by means of the switching element 32-7. Second terminal 6 of battery cell 1b is connected to first terminal 4 of battery cell 1c by means of the switching element 32-8.

The two battery cells 1a, 1d arranged at the edge in each case are so-called terminal battery cells of the N=4 battery cells 1a, 1b, 1c, 1d. In the terminal battery cells 1a, 1d, one of the two terminals 4, 6 is connected in each case to one of internal (or external) (battery) module terminals 14 (114), 16 (116). In FIG. 3A, first terminal 4 is connected to first internal module terminal 14 in left terminal battery cell 1a, and second terminal 6 is connected to second internal module terminal 16 in right terminal battery cell 1d. There are two terminal battery cells 1a and 1d, wherein one of terminals 4 and 6 of the two terminal battery cells 1a and 1d in each case forms one of the two external module terminals 114, 116.

Furthermore, in terminal battery cells 1a, 1d, the first or second terminal 4, 6 that is not connected to a module terminal 14, 16 can be connected to a corresponding first or second terminal 4, 6 of one of the other (immediately adjacent) (N−2=2) battery cells 1b or 1c by means of one of controllable switching elements 32-7 or 32-9. This means that first terminal 4 of right terminal battery cell 1d can additionally be connected to second terminal 6 of (immediately) adjacent battery cell 1c by means of controllable switching element 32-9. Second terminal 6 of left terminal battery cell 1a can additionally be connected to first terminal 4 of (immediately) adjacent battery cell 1b by means of controllable switching element 32-8.

By means of configuration circuit 30, N=4 battery cells 1a, 1b, 1c, 1d can be reconfigured to configurations 1P4S, 2P2S, 4P1S during operation, thus making it possible to set three different (battery) module voltages MS. Battery cells 1a, 1b, 1c, 1d each have a nominal cell voltage ZS, e.g., 3.7 V, such that nominal module voltage MS can be configured accordingly in stages, with the magnitude of nominal ca voltage ZS or a multiple thereof in a range from ZS up to N=4-fold nominal cell voltage ZS (4×3.7 V=14.8 V), by controlling switching elements 32-1, . . . 32-9 accordingly.

Module 100 of FIG. 3A further has a (battery) module control unit 20 that is operatively connected to respective switching elements 32-1, 32-2, 32-3, 32-4, 32-5, 32-6, 32-7, 32-8, 32-9 (32; 32-1, . . . 32-9) via corresponding control lines 21-1, 21-2, 21-3, 21-4, 21-5, 21-6, 21-7, 21-8, 21-9 (21; 21-1, . . . 21-9). Corresponding switching element 32 can be controlled via respective control line 21 in such a way that it conducts electrical current or blocks electrical current.

Module 100 also has a module control input 120 for receiving a module voltage control signal S1 for setting a selectable module voltage MS at module terminals 114, 116. A selectable module voltage MS corresponds in each case to one of the settable interconnection configurations—in the exemplary embodiment of FIG. 3A, to configurations 1P4S, 2P2S, 4P1S. Module control input 120 is operatively connected to module control unit 20.

Module control unit 20 is arranged to control the controllable switching elements 32-1, . . . 32-9 of configuration circuit 30 according to module voltage control signal S1, so as to set the interconnection of the individual battery cells to one of possible configurations 1P4S, 2P2S, or 4P1S according to the rule N=P×S. As a result, the interconnection of the N=4 battery cells 1a, 1b, 1c, 1d of module 100 is configured in such a way that nominal module voltage MS is set according to module voltage control signal S1.

FIG. 3B essentially shows a more practical, alternative representation of module 100 of FIG. 3A. Nang with circuit breakers 32 (32-1, 32-2, . . . 32-9), configuration circuit 30 is embodied on a circuit board 31 that is connected in an electrically conducting manner to respective first and second terminals 4 and 6 of battery cells 1a, . . . 1d by means of connection elements (not shown). Screws or rivets, for example, can be used as connection elements. According to the concept explained above, an individual switching element 32 is in each case connected between two of the first and second terminals 4 and 6 of battery cells 1a, . . . 1d serving as circuit nodes. Circuit board 31 thus essentially contains the power section of configuration circuit 30.

Module control unit 20 is operatively connected to each of switching elements 32 by means of a control line 21 (in each case indicated by arrows). Module control unit 20 can be designed as an integrated circuit (IC), e.g., as a micro-controller in a module, and likewise be located in a suitable place on circuit board 31. Module control unit 20 can be simultaneously designed for communication with a traction battery control unit.

Alternatively, it is possible for module control unit 20 to be arranged on a further control board (not depicted) and for control lines 21 to run between circuit board 31 and the control board via a corresponding interface, e.g., a fixed or flexible plug connection. In addition to external module terminals 114, 116, module 100, in any case, has at least one other control terminal, e.g., module control input 120, at which module 100 can be connected to an external interface for receiving module voltage control signal S1. For example, module control unit 120 can be part of an interface to an internal control bus system of a traction battery, wherein, in a manner known per se, the interface can have additional signal lines, control lines, and supply lines.

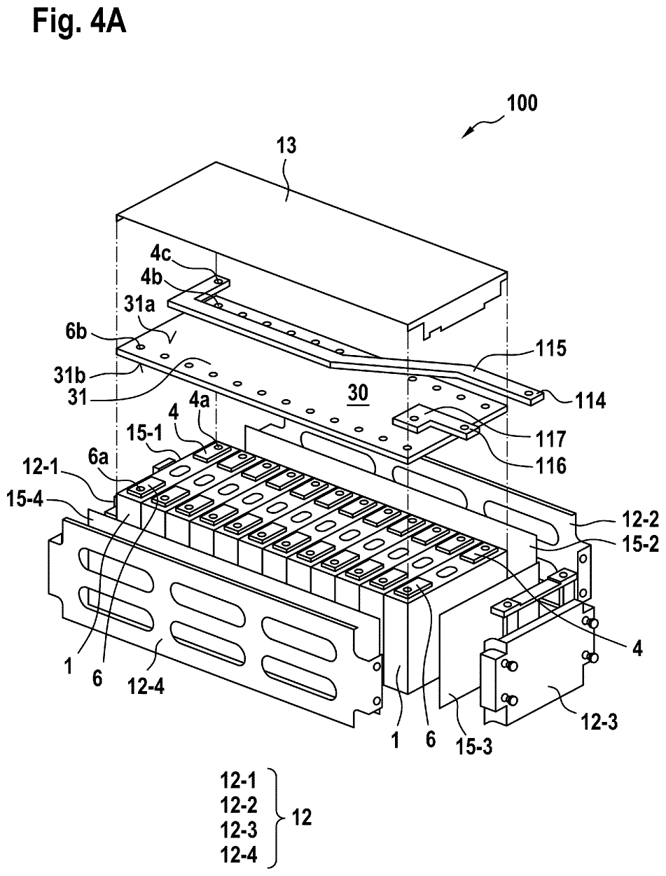

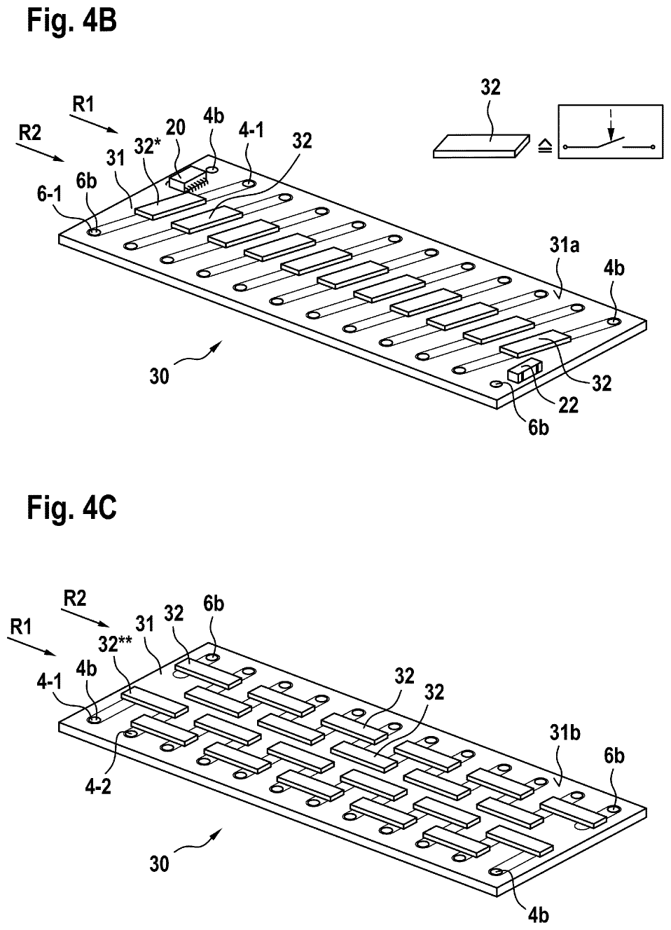

FIG. 4A shows a perspectival exploded view drawing of a possible exemplary embodiment of a (battery) module 100. In the lower region, twelve battery cells 1 are initially shown, wherein all battery cells 1 are arranged adjacent to one another in such a way that, given two adjacent battery cells 1 each, first terminals 4 and second terminals 6 of these adjacent battery cells 1 are located immediately adjacent to one another, i.e., the cells have the same orientation as first and second terminals 4, 6. This simplifies the design of module 100 from a manufacturing perspective, because all battery cells can be inserted into module housing 12 in the same orientation, thus making it easier to rule out errors, as are possible in conventional modules, in the arrangement of the battery cells.

The twelve battery cells 1 of module 100 are held together in a known manner in module housing 12 by four side walls 12-1, 12-2, 12-3, 12-4 that, when joined together, form module housing 12 by means of respective mechanical connections, such as, for example, screw connections. Electrical insulation in the form of insulation films 13-1, 13-2, 13-3, 13-4 is provided between side walls 12-1, 12-2, 12-3, 12-4 and battery cells 1.

Respective first and second terminals 4 and 6 of battery cells 1 are each arranged in a row in a longitudinal direction of module 100. First and second terminals 4 and 6 of battery cell 1 define the circuit nodes to be contacted by configuration circuit 30, between which nodes, according to the concept proposed here, controllable switching elements 32 are connected. For the purpose of contacting first and second terminals 4 and 6 of battery cells 1, contact bores having an internal thread are provided in each of terminals 4 and 6. This allows a terminal 4, 6 to be contacted by means of a suitable, electrically conductive screw.

Configuration circuit 30 is located on a circuit board 31 having an upper side 31a and an underside 31b. An exemplary embodiment of configuration circuit 30 having switching elements 32 is explained further below on the basis of FIGS. 4B and 4C. Above circuit board 31, two conductor rails (busbars) 115 and 117 are depicted that each produce a connection between one of the external terminals 114 and 116 of module 100 and the corresponding internal terminal battery cell of module 100.

The dimensions of circuit board 31 are roughly defined by the surface formed by the whole of the upper sides of battery cells 1. Contact through-holes are provided in circuit board 31 corresponding to the positions of the contact holes in first and second terminals 4 and 6 of battery cells 1. If circuit board 31 is arranged in the installed position above battery cells 1, a contact hole is located below a corresponding contact through-hole in each case.

Two examples are given to explain the contact principle. For example, contact hole 6a is below contact through-hole 6b. For example, contact hole 4a is below through-hole 4b, which is, in turn, below through-hole 4c in power rail 115.

Thus, the necessary electrical connections between the contact holes and the corresponding contact through-hole can be produced by means of a corresponding electrical contact element, such as a conducting screw. A screw connection allows for easy disassembly of module 100 for the purpose of repairs or recycling.

As an alternative to producing electrical conducting connections by means of screws, the necessary electrically conductive connections can also be produced with a rivet. A rivet connection can be produced faster during manufacturing, but is not as easy to remove again.

Module 100 is closed above power rails 115, 117 with a module cover 13 made of an insulation material.

FIGS. 4B and 4C each show in detail a perspectival representation of upper side 30a and underside 30b of circuit board 31 having configuration circuit 30 of the exemplary embodiment of battery module 100 in FIG. 4A. It should be mentioned that the construction of circuit board 31 described below is described purely by way of example, to facilitate the understanding of the concept presented here.

The through-holes of circuit board 31 corresponding to first and second terminals 4 and 6 of battery cells 1 are arranged in corresponding rows R1 and R2 and are the circuit nodes of configuration circuit 30 between which, according to the concept presented here, switching elements 32 are arranged.

In FIG. 4B, upper side 31a of circuit board 31 is shown. The switching elements 32 arranged on upper side 31a of circuit board 31 are used to interconnect two immediately adjacent battery cells 1 such that, in each case, a first terminal 4 of the one battery cell can be connected electrically to a second terminal 6 of immediately adjacent battery cell 1 by means of respectively associated switching element 32.

For example, at through-hole 6b, second terminal 6-1 of the battery cell there can be connected to first terminal 4-1 of the immediately adjacent battery cell via switching element 32*. The same applies to the rest of battery cells 1.

In FIG. 4C, corresponding underside 31b of the circuit board 31 from FIG. 3B is shown. The switching elements 32 arranged on underside 31b of circuit board 31 are used to interconnect two immediately adjacent battery cells 1 such that, in each case, a first terminal 4 of one battery cell can be connected electrically to a first terminal 4 of immediately adjacent battery cell 1 by means of a switching element 32 and such that, in each case, a second terminal 6 of one battery cell can be connected electrically to a second terminal 6 of immediately adjacent battery cell 1 by means of respectively associated switching element 32.

For example, first terminal 4-1 of the battery cell there can be connected to first terminal 4-2 of the immediately adjacent battery cell via switching element 32**. The same applies to the rest of the battery cells 1.

In FIGS. 4B and 4C, only the power section of configuration circuit 30 that is formed by the circuit nodes and switching elements 32 and the corresponding conductors is shown. Module control unit 20 is not depicted in FIGS. 4A-4C.

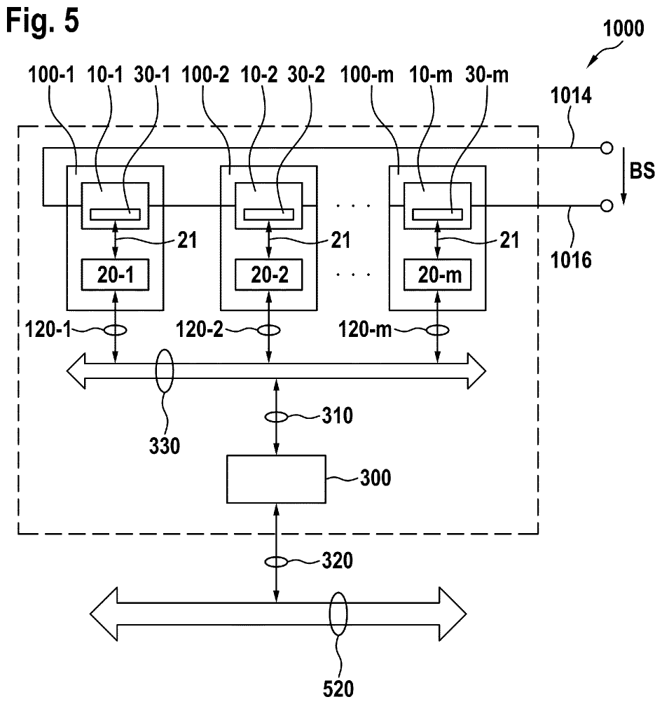

Module control unit 20 can be implemented as a micro-controller that is simultaneously designed for connecting module 100 to a communication bus 320 of a traction battery 1000 (cf. FIG. 5). For this purpose, module control unit 20 can also be located on circuit board 31 and, via respective control lines, operatively connected to each of switching elements 32, in order to, in their function as a switch, switch the switching elements on (i.e., conducting) or off (i.e., blocking). This variant is indicated by dashed box 20 in FIG. 4B. For the connection to communication bus 320 of traction battery 1000, a mechanical interface in the form of a plug connection 22 is shown.

As an alternative (not depicted), the module control unit 20 implemented as a micro-controller can be located on a separate circuit board, which is likewise connected to circuit board 31 via a mechanical interface in the form of a plug connection. The plug connection for the connection to communication bus 320 of traction battery 1000 would also still be located on the separate circuit board.

FIG. 5 shows a simplified block diagram of a flexibly configurable traction battery 1000 that is constructed from a number m of interconnected (battery) modules 100 (100-1, 100-2, . . . 100-m), such as module 100 from FIGS. 3A and 3B. Traction battery 1000 has a first and a second traction battery terminal 1014, 1016, between which the several modules 100 are connected.

In the embodiment of FIG. 5, modules 100 are connected to each other in series between the two traction battery terminals (1014, 1016).

Furthermore, traction battery 1000 has a traction battery control unit 300. Traction battery control unit 300 is operatively connected to respective (battery) module control inputs 120 (120-1, 120-2, . . . 120-m) of (battery) module control units 20 (20-1, 20-2, . . . 20-m) of (battery) modules 100 via a (battery) module control output 310. The plurality of necessary connections is realized in the embodiment shown in that traction battery control unit 300 is operatively connected via battery-module control output 310, and respective battery-module control outputs 120 of battery modules 100 are operatively connected via a communication bus 320 inside the traction battery.

Communication bus 320 can, for example, be a fieldbus, such as a CAN bus (as defined in ISO 11898, ISO 11898-2/high-speed CAN, or ISO 11898-3/low-speed CAN) or RexRay (as defined in ISO 17458-1 to 17458-5), to name two examples, or it can be any other suitable control bus.

Traction battery control unit 300 can selectively set individual battery modules 100, as discussed in connection with FIGS. 3A and 3B, to one of the possible configurations, via the control connection implemented between traction battery control unit 300 and module control units 20 by means of communication bus 320. As a result, traction battery control unit 300 can set or change traction battery voltage BS at the two traction battery terminals 1014, 1016—if necessary, during ongoing operation.

To communicate with other system components of a vehicle, e.g., an electric vehicle, traction battery control unit 300 can also itself be connected to a system bus 520 of the vehicle via an existing communication interface 320.

System bus 520 can, for example, also be a fieldbus, such as a CAN bus (as defined in ISO 11898, ISO 11898-2/high-speed CAN, or ISO 11898-3/low-speed CAN) or RexRay (as defined in ISO 17458-1 to 17458-5), to name two examples, or it can be any other suitable control bus.

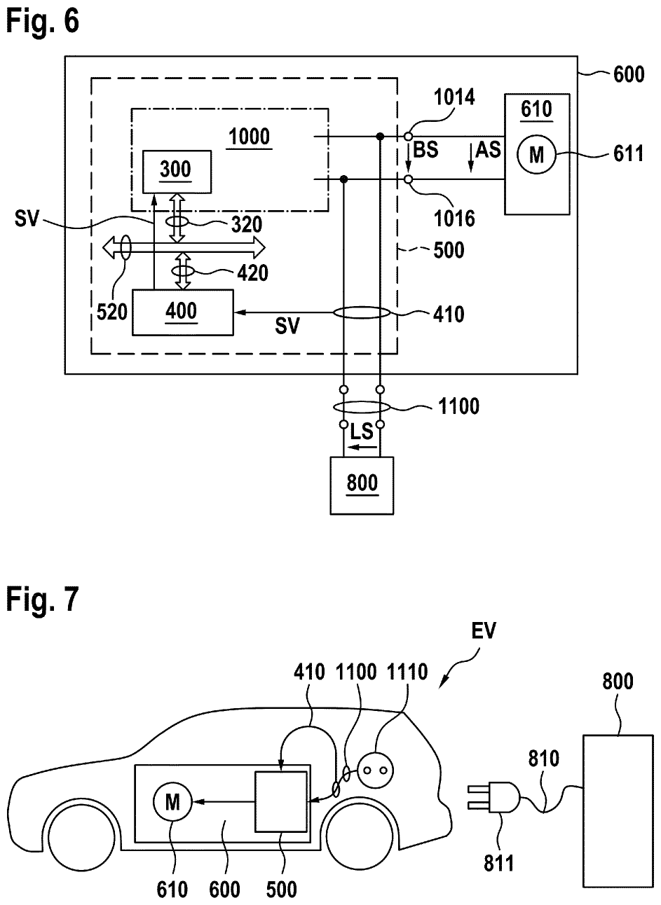

FIG. 6 shows a simplified block diagram of an electric drive system 600 having the traction battery 1000 of FIG. 5.

Part of electric drive system 600 is formed by a traction battery system 500, to which traction battery 1000 belongs. Traction battery 500 has a charging voltage unit 400 that is, among other things, arranged to determine the magnitude of an available (for example, at a charging station 800) charging voltage LS as charging voltage information SV and transmit it to traction battery control unit 300. The charging voltage information SV can, for example, be obtained or detected by charging voltage unit 400 by means of corresponding signaling or coding 410 on the part of charging station 800. For this purpose, charging voltage unit 400, via a communication interface 420, is likewise operatively connected to system bus 520, and also to traction battery control unit 300.

Based upon charging voltage information SV concerning available charging voltage LS, traction battery control unit 300 can control the several battery modules 100 (cf. FIG. 5: 100-1, 100-2, . . . 100-m), i.e., control respective configuration circuits 30 (cf. FIG. 5: 30-1, 30-2, . . . 30-m), in order to configure traction battery 1000 as a whole in such a way that a traction battery voltage BS that matches available charging voltage LS is set between the two traction battery terminals 1014, 1016. Thus, a wide range of available charging voltages can be set as desired, within the scope of the settable configurations predetermined by the construction of battery modules 100. Traction battery 1000 is thus arranged such that traction battery 1000 can be charged with a significantly higher voltage than the vehicle usually requires internally. As a result, the charging times can be significantly reduced.

Alternatively or additionally, traction battery control unit 300 can control the several battery modules 100 (cf. FIG. 5: 100-1, 100-2, . . . 100-m), i.e., configuration circuits 30 (cf. FIG. 5: 30-1, 30-2, . . . 30-m) during operation, i.e., when electrical energy is drawn from traction battery 1000, in such a way that a traction battery voltage BS corresponding to a predetermined traction battery voltage AS for supplying energy to an electric drive 610 (e.g., an electric motor) is set at the two traction battery terminals 1014, 1016.

Electric drive 610 can have an efficiency profile. That is, drive 610, e.g., a combination of a three-phase motor and an inverter, may work particular energy-efficient, and thus with maximum efficiency, in a predetermined range of the traction battery voltage BS provided to drive 610 by traction battery 1000 as a drive voltage AS. Therefore, when traction battery 1000 delivers energy to drive 610, traction battery control system 300 can control the several battery modules 100, in order to configure traction battery 1000 in such a way that traction battery voltage BS set at the two traction battery terminals 1014, 1016 is within the optimum range of the efficiency profile of electric drive 610, or comes as dose to it as possible.

Electric drive system 600 of FIG. 6 thus consists of at least one electric motor 611, as an electric drive 610, and traction battery system 500 having traction battery 1000 for supplying the electric motor 611 with electrical energy.

Electric motor 611 can, for example, be a direct-current motor that is connected to traction battery 1000 of traction battery system 500—for example, via a power control unit (not shown).

Electric motor 611 can, alternatively, be a three-phase motor that is connected to traction battery 1000 of traction battery system 500 via an inverter (not shown) having controllable output power.

FIG. 7 shows a simplified block diagram of an electric vehicle EV having a drive system 600, as it was described, for example, in connection with FIG. 6. A charging station 800 having a charging cable 810 is provided for coupling to a corresponding charging socket 1110 of electric vehicle EV by means of a charging plug 811 of charging cable 810. Charging cable 810 can, of course, also be a separate part of charging station 800 and electric vehicle EV. In this case, a plug connection known per se is likewise provided for connecting to charging station 800.

Charging voltage information SV can be obtained or detected in an appropriate manner by charging voltage unit 400 (cf. FIG. 6) of traction battery system 500, e.g., by means of corresponding signaling or coding 410 on the part of charging station 800, and transmitted (for example, by means of communication between charging station 800 and electric vehicle eV, as defined in ISO/EC 15118) to traction battery 1000, i.e., associated traction battery control unit 300 (cf. FIGS. 5 and 6), in order to carry out the adaptation of traction battery voltage BS to charging voltage LS explained above in connection with FIG. 6.

The above detailed description only illustrates certain exemplary embodiments of the present disclosure, and is not intended to limit the scope of the present disclosure. Those of ordinary skill in the art understand the description as a whole so that technical features described in connection with the various embodiments can be combined into other embodiments understandable to those of ordinary skill in the art. Also any equivalent or modification of the described embodiments as well as combinations thereof do not depart from the spirit and principle of the present disclosure and falls within the scope of the present disclosure as well as of the appended claims. As such, provided that these modifications and variants fall into the scope of the claims and equivalent technologies thereof, it is intended to embrace them within the present disclosure as well.

1. A battery module for a traction battery of an electric vehicle (EV), wherein the battery module comprises a number N of battery cells, each having a first terminal and a second terminal, as well as a configuration circuit for selectively configuring the interconnection of the battery cells to change a module pole voltage (MS) between battery-module terminals of the battery module, and
wherein the configuration circuit is connected to all first and second terminals of the battery cells and arranged to form a first number S of battery-cell groups, each containing a second number P of battery cells, in that the configuration circuit can connect all battery cells of a battery-cell group in parallel and interconnect the battery-cell groups in series, wherein the selectable interconnection configurations meet the condition P×S=N.

2. The battery module according to claim 1, wherein
the configuration circuit has electrically controllable switching elements; and,
in battery cells of the N battery cells, the first terminal can be connected electrically to the first terminals of two other battery cells of the N battery cells, and the second terminal can be connected electrically to the second terminals of these two other battery cells by means of a corresponding one of the controllable switching elements, and the first terminal can be connected electrically to the second terminal of a first battery cell of the two other battery cells, and the second terminal can be connected electrically to a first terminal of a second battery cell of the two other battery cells by means of a corresponding one of the controllable switching elements.

3. The battery module according to claim 2, wherein,
in a terminal battery cell of the N battery cells, the first terminal and the second terminal can be connected to a corresponding first terminal or second terminal of one of the N−2 battery cells by means of a corresponding one of the controllable switching elements.

4. The battery module according to claim 3, wherein,
in a terminal battery cell of the N battery cells, one of the first terminal and the second terminal is connected to one of the two battery-module terminals, and the other of the first terminal and the second terminal can additionally be connected to one of the terminals of the one battery cell of the N−2 battery modules by means of a corresponding one of the controllable switching elements, wherein
it is possible to connect the second terminal of the terminal battery cell to the first terminal of the one battery cell of the N−2 battery cells when the first terminal of the terminal battery cell is connected to one of the two battery-module terminals, and
it is possible to connect the first terminal of the terminal battery cell to the second terminal of the one battery cell of the battery cells when the second terminal of the terminal battery cell is connected to one of the two battery-module terminals.

5. The battery module according to claim 1, wherein
the controllable switching elements each have at least one power semiconductor that is controllable as a switch.

6. The battery module (100) according to claim 1, wherein
the switching elements each have at least one power semiconductor from the following group, consisting of: insulated-gate bipolar transistors, power metal oxide semiconductor field-effect transistors, and thyristor switches.

7. The battery module according to claim 1, wherein
the battery cells are each secondary battery cells and have a battery-cell voltage (ZS); and
the battery-module voltage (MS) of the battery module can be configured in stages, with the magnitude of the battery-cell voltage (ZS) or a multiple of the battery-cell voltage (ZS) in a range from a battery-cell voltage BS) up to the N-fold battery-cell voltage (N×ZS), by controlling the controllable switching elements accordingly.

8. The battery module according to claim 1, wherein
the battery module also has:
a battery-module control unit that is operatively connected to the controllable switching elements of the configuration circuit of the battery module;
a battery-module control input for receiving a battery-module voltage control signal for setting a selectable battery-module voltage (MS) at the battery-module terminals, wherein the battery-module control input is operatively connected to the battery-module control unit; and
wherein the battery-module control unit is arranged to control the configuration circuit according to the battery-module voltage control signal such that the interconnection of the N battery cells of the battery module is configured in such a way that the battery-module voltage (MS) is set according to the battery-module voltage control signal.

9. The battery module according to claim 1, wherein
all battery cells are arranged next to each other in the battery module in such a way that, in the adjacent battery cells, the first terminals and the second terminals of the adjacent battery cells are next to each other.

10. A traction battery comprising:
at least two traction battery terminals, a plurality of battery modules, and a traction battery control unit, wherein each battery module comprises a number N of battery cells, each having a first terminal and a second terminal, as well as a configuration circuit for selectively configuring the interconnection of the battery cells to change a module pole voltage (MS) between battery-module terminals of the battery module,
wherein the configuration circuit is connected to all first and second terminals of the battery cells and arranged to form a first number S of battery-cell groups, each containing a second number P of battery cells, in that the configuration circuit can connect all battery cells of a battery-cell group in parallel and interconnect the battery-cell groups in series, wherein the selectable interconnection configurations meet the condition P×S=Nand, and
wherein the traction battery control unit is operatively connected to the respective battery-module control inputs of the battery modules via a battery-module control output.

11. The traction battery according to claim 10, wherein
the traction battery control unit, via the battery-module control output and the respective battery-module control inputs of the battery modules, is coupled communicatively via a communication bus.

12. The traction battery according to claim 10, wherein
the traction battery control unit is further coupled to a charging voltage unit that is arranged to determine the magnitude of an available charging voltage (LS) and transmit it to the traction battery control unit.

13. The traction battery according to claim 12, wherein
the traction battery control unit is arranged to control the several battery modules in order to configure the traction battery as a whole in such a way that, at the two traction battery terminals, a traction battery voltage (BS) is set that matches the available charging voltage (LS).

14. The traction battery according to claim 10, wherein
the traction battery control unit is further arranged to control the several battery modules when electrical energy is drawn from the traction battery, in order to configure the traction battery in such a way that, at the two traction battery terminals, a traction battery voltage (BS) can be set that matches a predetermined drive voltage (AS) for supplying energy to an electric drive.

15. The traction battery according to claim 14, wherein
the electric drive (610) has an efficiency profile according to which the drive works in an energy-efficient manner in a predetermined range of a drive voltage (AS) provided to the drive, and
the traction battery control unit is further arranged to control the several battery modules, when the traction battery is to deliver energy to the drive, in order to configure the traction battery in such a way that the traction battery voltage (AS) set at the two traction battery terminals is within the predetermined efficiency range of the efficiency profile of the electric drive, or comes as close to it as possible.

16. The traction battery according to claim 10, wherein
the battery modules are connected to each other in series between the two traction battery terminals.

17. An drive system having at least one electric motor as an electric drive, and a traction battery for supplying the electric motor with electrical energy, wherein the traction battery comprises:
at least two traction battery terminals, a plurality of battery modules, and a traction battery control unit, wherein each battery module comprises a number N of battery cells, each having a first terminal and a second terminal, as well as a configuration circuit for selectively configuring the interconnection of the battery cells to change a module pole voltage (MS) between battery-module terminals of the battery module,
wherein the configuration circuit is connected to all first and second terminals of the battery cells and arranged to form a first number S of battery-cell groups, each containing a second number P of battery cells, in that the configuration circuit can connect all battery cells of a battery-cell group in parallel and interconnect the battery-cell groups in series, wherein the selectable interconnection configurations meet the condition P×S=Nand, and
wherein the traction battery control unit is operatively connected to the respective battery-module control inputs of the battery modules via a battery-module control output.

18. The electric drive system according to claim 17, wherein
the electric motor is a direct-current motor that is connected to the traction battery or a three-phase motor that is connected to the traction battery via an inverter.

19. An electric vehicle (EV) having an electric drive system comprising at least one electric motor as an electric drive, and a traction battery for supplying the electric motor with electrical energy, wherein the traction battery comprises:
at least two traction battery terminals, a plurality of battery modules, and a traction battery control unit, wherein each battery module comprises a number N of battery cells, each having a first terminal and a second terminal, as well as a configuration circuit for selectively configuring the interconnection of the battery cells to change a module pole voltage (MS) between battery-module terminals of the battery module,
wherein the configuration circuit is connected to all first and second terminals of the battery cells and arranged to form a first number S of battery-cell groups, each containing a second number P of battery cells, in that the configuration circuit can connect all battery cells of a battery-cell group in parallel and interconnect the battery-cell groups in series, wherein the selectable interconnection configurations meet the condition P×S=Nand, and
wherein the traction battery control unit is operatively connected to the respective battery-module control inputs of the battery modules via a battery-module control output.
